(19) United States
(12) Patent Application Publication
(10) Pub. No.: US 2026/0329257 A1
(43) Pub. Date: Oct. 22, 2026

(54) On-Machine Metrology for Manufacturing Machine

(71) Applicant: 4MP, Inc., Allentown, PA (US)

(72) Inventor: Marcin B. Bauza, Allentown, PA (US)

(21) Appl. No.: 19/698,592

(22) Filed: Jun. 4, 2026

Related U.S. Application Data
(63) Continuation of application No. PCT/IB2024/062233, filed on Dec. 4, 2024.
(60) Provisional application No. 63/606,061, filed on Dec. 4, 2023.
(60) Provisional application No. 63/622,507, filed on Jan. 18, 2024.
(60) Provisional application No. 63/684,324, filed on Aug. 16, 2024.
(60) Provisional application No. 63/726,274, filed on Nov. 28, 2024.

(51) Int. Cl. G05B 19/4155

(52) U.S. Cl. CPC G05B 19/4155; G05B 2219/49205

(57) ABSTRACT

A method for machining a workpiece includes receiving calibration data for a primary sensor generated by measuring a calibration artifact at multiple orientations of a workpiece movement mechanism. Machining data defines nominal three-dimensional geometry of intended workpiece states in a nominal coordinate system, including a first feature formed by a first material-modification operation. After the first feature is formed and while the workpiece remains mounted, the sensor measures the first feature. A calibrated three-dimensional geometry of the first feature is generated from sensor measurement data, orientation data, and the calibration data to correct deviations introduced by the movement mechanism. Geometric differences between the calibrated geometry and nominal geometry are determined using tied sensor, nominal, and machine coordinate systems. A following portion of the machining data is modified using a transformation among the tied coordinate systems before a subsequent material-modification operation.

### CROSS-REFERENCE TO RELATED APPLICATIONS

This application is a bypass continuation of International Application No. PCT/IB2024/062233 filed Dec. 4, 2024, which claims the benefit of U.S. Provisional Application No. 63/606,061 filed Dec. 4, 2023, U.S. Provisional Application No. 63/622,507 filed Jan. 18, 2024, U.S. Provisional Application No. 63/684,324 filed Aug. 16, 2024, and U.S. Provisional Application No. 63/726,274 filed Nov. 28, 2024. The entire disclosures of the above applications are incorporated by reference.

### FIELD

The present disclosure relates to manufacturing machines and more particularly to closed-loop control for manufacturing machines.

### BACKGROUND

Manufacturing has progressed from computer numerical control (CNC) in the 1950s to probing systems in the 1980s and adaptive control and compensation in the 1990s. However, integrating full coordinate measurement machine (CMM) functionality within a CNC system remains impractical. This disclosure recognizes a need to further improve computer-aided manufacturing (CAM) by closing the loop in manufacturing. Closing the loop may mean improving feedback on the dimensional accuracy of workpieces during the machining process without removing the workpiece from the CNC system. Existing solutions for correcting errors in CNC systems rely on sensor measurements gathered from motion of the machine axis of the CNC system. Therefore, it is not possible to decouple (and adjust for) the machining error from the collected sensor data. Additionally, if the workpiece is measured by a sensor that is not connected to the CNC system, current systems are unable to effectively tie together the coordinate systems of the CNC system and the sensor measuring the workpiece, which means it is not currently possible to correct the CAM code based on the sensor measurement. Further, existing solutions for correcting errors in CNC systems cannot accurately measure geometrical errors such as squareness and straightness; therefore, parts are generally removed from the CNC system and measured with a separate system, such as a coordinate measuring machine (CMM) or other metrology solution. However, it is expensive and difficult—if not impossible—to re-mount the part precisely back on the CNC system to perform corrective/final machining. As a result, parts requiring correction are often discarded.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes receiving data associated with a workpiece mounted in a manufacturing machine. The method includes, following performance of a first machining operation on the workpiece by the manufacturing machine that generates a first feature on the workpiece, gathering a first data set. The method includes gathering a second data set. The method includes determining a difference data set based on differences between the first data set and the second data set. The method includes modifying the data based on the difference data set. The method includes causing the manufacturing machine to use the modified data in performing an additional machining operation on the workpiece.

In other features, modifying the data includes generating a modified data set based on the difference data set, and the manufacturing machine uses the modified data set to perform the additional machining operation. In other features, the method includes predicting, by an artificial intelligence (AI) module, a behavior of the manufacturing machine based on at least one of: feedback or data received from the manufacturing machine. In other features, the data includes at least one of: computer-aided manufacturing (CAM) code, computer-aided design (CAD) code, digital twin data, design intent data, or point cloud data. In other features, gathering the first data set includes measuring the first feature using a primary sensor. In other features, gathering the first data set includes measuring the first feature using a primary sensor and a secondary sensor. In other features, gathering the second data set includes retrieving the second data set from the data. In other features, gathering the second data set includes measuring the first feature using a secondary sensor.

In other features, the method includes updating a log based on the difference data set. In other features, the method includes outputting a report based on the log. In other features, the method includes updating a digital twin based on the log.

In other features, the primary sensor includes a camera. In other features, the primary sensor includes a plurality of cameras. In other features, the primary sensor is a contact sensor. In other features, the contact sensor is a tactile sensor. In other features, the primary sensor is a non-contact sensor. In other features, the non-contact sensor includes at least one of a camera, a laser scanner, or an x-ray sensor.

In other features, the secondary sensor is a contact sensor. In other features, the contact sensor is a tactile sensor. In other features, the secondary sensor is a non-contact sensor. In other features, the non-contact sensor includes at least one of a camera, a laser scanner, or an x-ray sensor. In other features, the manufacturing machine is a computer numerical control (CNC) machine. In other features, the manufacturing machine is one or more robots. In other features, the additional machining operation at least partially removes the first feature from the workpiece. In other features, the additional machining operation machines a portion of the workpiece separate from the first feature.

In other features, the manufacturing machine includes a spindle configured to retain a removal tool used in the first machining operation, and the spindle is also configured to retain the secondary sensor. In other features, the removal tool is at least one of: an end mill, a thru machining tool, a drill bit, a grinding tool, a polishing tool, an electrical discharge machining (EDM) tool, a diamond turning tool, a diamond cutting tool or a honing tool. In other features, the removal tool is any tool capable of removing material from the workpiece.

In other features, the manufacturing machine includes a spindle that retains a removal tool used in the first machining operation, and the secondary sensor is affixed to the spindle and remains affixed to the spindle while the first machining operation is performed. In other features, the manufacturing machine includes a workpiece movement mechanism configured to receive the workpiece. In other features, the workpiece movement mechanism is a rotary mechanism configured to rotate the workpiece around a vertical axis. In other features, the workpiece movement mechanism is a kinematic seat.

In other features, the method includes measuring a calibration artifact mounted in the manufacturing machine using a primary sensor to generate a calibration data set. The method includes calibrating the primary sensor based on known properties of the calibration artifact, a known mounting location of the calibration artifact with respect to the manufacturing machine, and the calibration data set. In other features, the method includes: aligning a coordinate system of the manufacturing machine with a coordinate system of the primary sensor. In other features, the coordinate system of the manufacturing machine is a coordinate system associated with a workpiece movement mechanism of the manufacturing machine. In other features, the coordinate system of the manufacturing machine is a coordinate system associated with a spindle of the manufacturing machine.

In other features, the workpiece is mounted on a stationary portion of the manufacturing machine, gathering the first data set includes measuring the first feature using a plurality of primary sensors, each primary sensors of the plurality of primary sensors performs a respective measurement of the first feature from a respective angle, and gathering the first data set includes combining the respective measurements from each primary sensor of the plurality of primary sensors to generate the first data set.

In other features, the method includes measuring a calibration artifact mounted on the stationary portion of the manufacturing machine with each primary sensor of the plurality of primary sensors to generate a calibration data set. Each primary sensor of the plurality of primary sensors generates a respective calibration measurement. Generating the calibration data set includes combining the respective calibration measurements of each primary sensor of the plurality of primary sensors. Combining the respective calibration measurements includes aligning respective coordinate systems of each primary sensor of the plurality of primary sensors. The method includes calibrating each primary sensor of the plurality of primary sensors based on known properties of the calibration artifact, a known mounting location of the calibration artifact with respect to the manufacturing machine, and the calibration data set.

In other features, the workpiece is mounted on a workpiece movement mechanism of the manufacturing machine, gathering the first data set includes measuring the first feature using a plurality of primary sensors, each primary sensors of the plurality of primary sensors performs a respective measurement of the first feature from a respective angle, and gathering the first data set includes combining the respective measurements from each primary sensor of the plurality of primary sensors to generate the first data set.

In other features, the method includes measuring a calibration artifact mounted on the workpiece movement mechanism of the manufacturing machine with each primary sensor of the plurality of primary sensors to generate a calibration data set. Each primary sensor of the plurality of primary sensors generates a respective calibration measurement. Generating the calibration data set includes combining the respective calibration measurements of each primary sensor of the plurality of primary sensors. Combining the respective calibration measurements includes aligning respective coordinate systems of each primary sensor of the plurality of primary sensors. The method includes calibrating each primary sensor of the plurality of primary sensors based on known properties of the calibration artifact, a known mounting location of the calibration artifact with respect to the manufacturing machine, and the calibration data set. In other features, the manufacturing machine is an additive manufacturing machine. In other features, the manufacturing machine is a hybrid manufacturing machine.

A manufacturing controller includes a primary sensor, memory hardware configured to store computer-executable instructions, and processor hardware configured to execute the computer-executable instructions. The computer-executable instructions embody any of the above methods. In other features, the primary sensor is fixedly mounted to a frame of the manufacturing machine.

A manufacturing system includes the above manufacturing controller and the manufacturing machine. A manufacturing controller includes a primary sensor, cloud-based memory configured to store computer-executable instructions, and processor hardware configured to execute the computer-executable instructions. The computer-executable instructions embody any of the above methods.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of a closed-loop manufacturing system according to the principles of the present disclosure performing a calibration operation.

FIG. 2 is a perspective view of a calibration artifact according to the principles of the present disclosure.

FIG. 3A is a functional block diagram of a closed-loop manufacturing system according to the principles of the present disclosure performing a first machining operation.

FIG. 3B is a functional block diagram of the closed-loop manufacturing system performing a measurement.

FIG. 3C is a functional block diagram of the closed-loop manufacturing system performing a second machining operation.

FIG. 4 is a functional block diagram of a closed-loop manufacturing control module according to the principles of the present disclosure.

FIG. 5 is a graphical representation of measurement points on a workpiece according to the principles of the present disclosure.

FIG. 6 is a flowchart of an example operation of a closed-loop manufacturing system according to the principles of the present disclosure.

FIG. 7 is a flowchart of an example calibration operation of a closed-loop manufacturing system according to the principles of the present disclosure.

FIG. 8A is a flowchart of example manufacturing operations based on primary measurements and CAD/CAM code.

FIG. 8B is a flowchart of example manufacturing operations based on primary and secondary measurements and CAD/CAM code.

FIG. 8C is a flowchart of example manufacturing operations based on primary and secondary measurements.

In the drawings, reference numbers may be reused to identify similar and/or identical elements.

### DETAILED DESCRIPTION

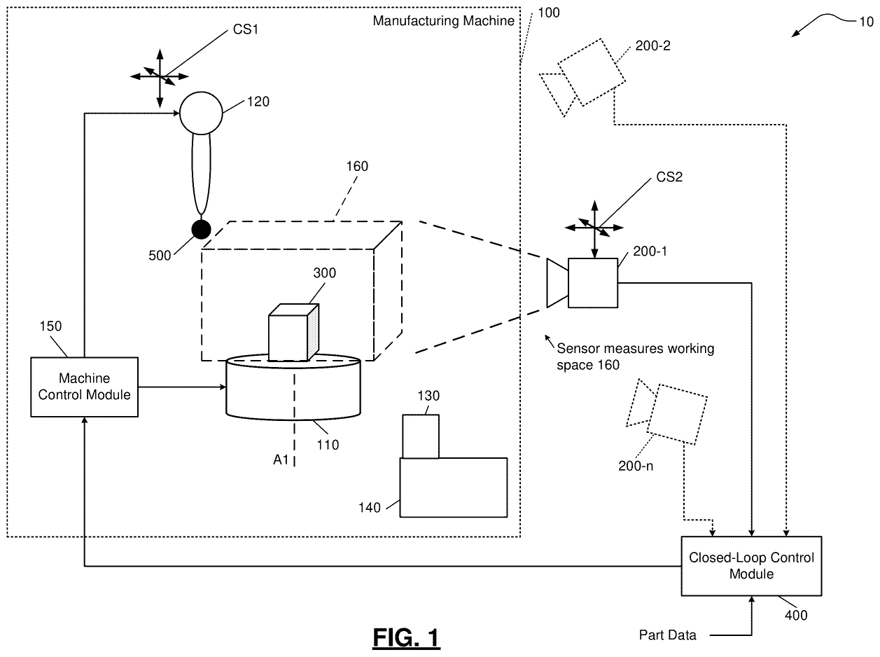

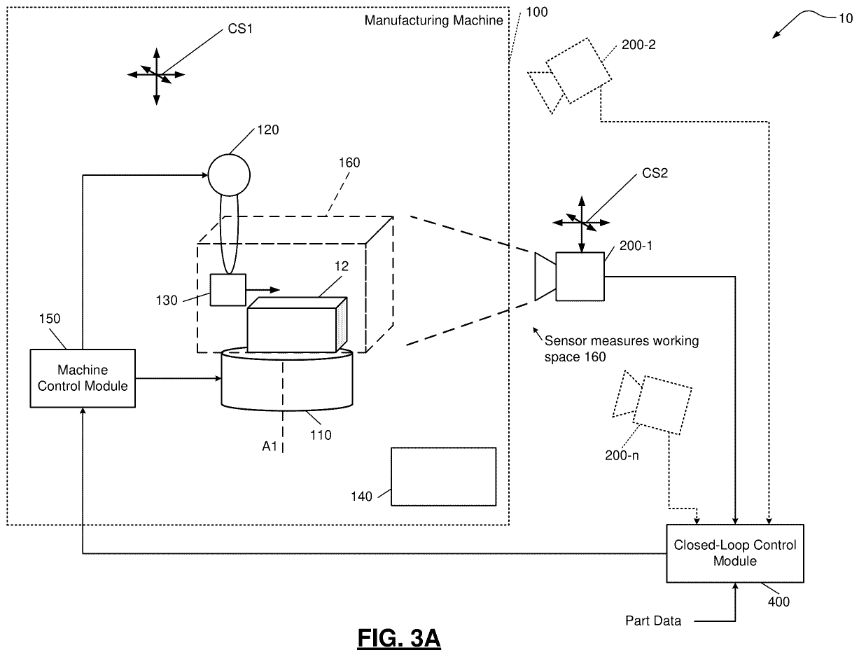

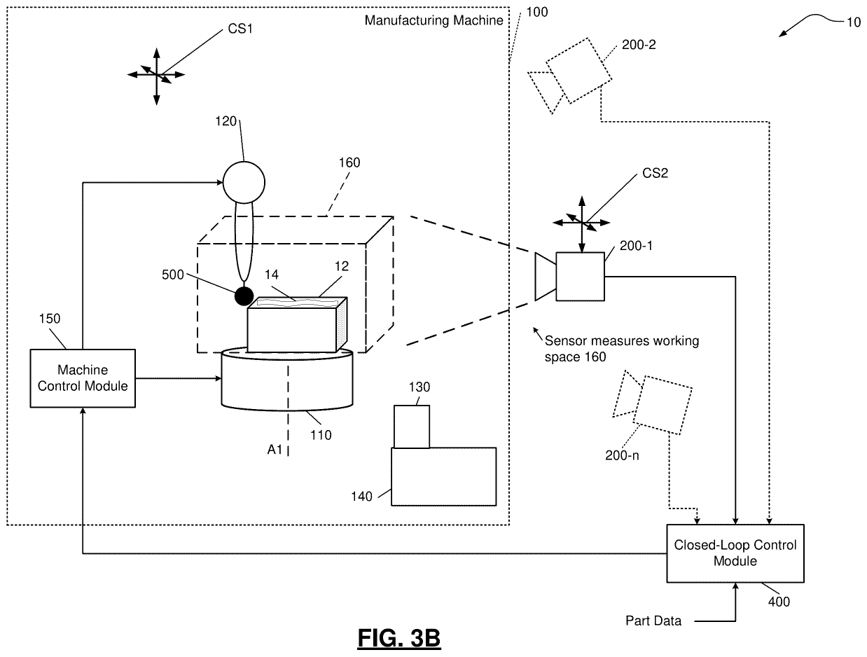

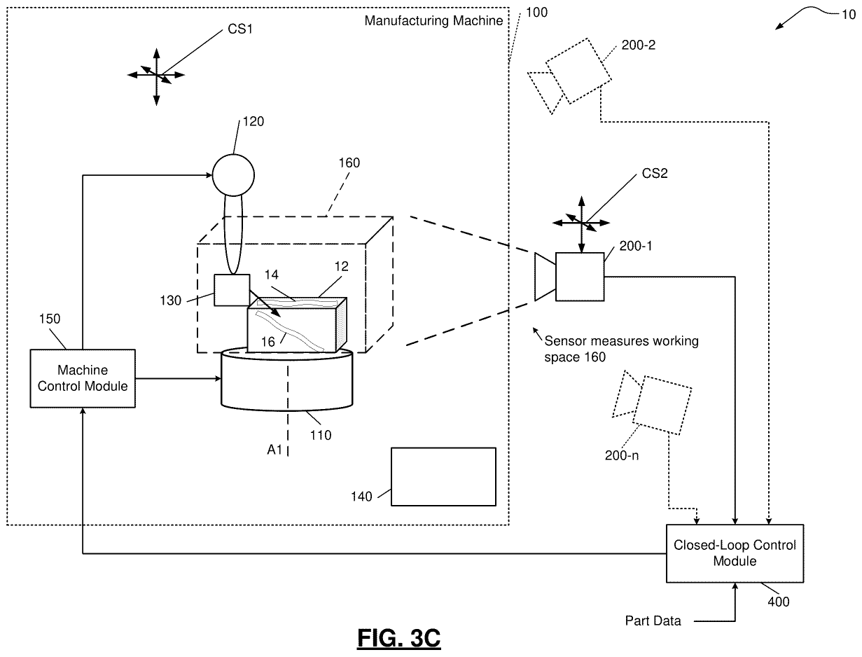

FIGS. 1 and 3A-3C illustrate a manufacturing system 10. As explained in more detail below, the manufacturing system 10 is used to perform manufacturing operations on a workpiece 12 (shown in FIGS. 3A-3C). For example, the manufacturing system 10 may be used to create parts or products for any number of industries, such as the aerospace, automotive, consumer goods, consumer electronics, semiconductor machinery, defense, energy, medical, and oil and gas industries.

The manufacturing system 10 includes a manufacturing machine 100, a primary sensor 200, and a closed-loop manufacturing control module 400. The manufacturing machine 100 may be an open-loop manufacturing machine or a closed-loop manufacturing machine. In various implementations, the primary sensor 200 may be accompanied by one or more additional primary sensors. In the example implementation depicted in FIGS. 1 and 3A-3C, there are n primary sensors 200-1, 200-2, . . . 200-n that together constitute the primary sensor 200. In implementations where there are multiple primary sensors, a reference to the primary sensor 200 can be understood as a reference to all of the primary sensors, individually or as a collective. In various implementations, the manufacturing system 10 includes a secondary sensor 500. In such implementations, the manufacturing system 10 may include one or more additional secondary sensors (not shown). Description related to the secondary sensor 500 may be applicable to the additional secondary sensors.

The manufacturing machine 100 may include a workpiece movement mechanism 110, a spindle 120, a machine tool 130, a tool holder 140, and a machine control module 150. The manufacturing machine 100 may define a working space 160 and a first coordinate system CS1. The working space 160 may be defined as the space within which the manufacturing machine 100 is capable of manipulating/manufacturing the workpiece 12 (e.g., performing a machining operation). The manufacturing machine 100 may be any machine capable of performing additive, subtractive, and/or hybrid manufacturing operations. For example, the manufacturing machine 100 may be a computer numerical control (CNC) machine or a three-dimensional (3D) printer. In various implementations, the manufacturing machine 100 is one or more robots.

In various implementations, a calibration artifact 300 may be used to calibrate the primary sensor 200. The workpiece movement mechanism 110 may receive the calibration artifact 300 and move the calibration artifact 300 within the working space 160 of the manufacturing machine 100. Operation of the workpiece movement mechanism 110 described with respect to the calibration artifact 300 may apply equally to the workpiece 12. The workpiece movement mechanism 110 may include a fixture and/or jig for securing the calibration artifact 300 to the workpiece movement mechanism 110. The fixture and/or jig may prevent the calibration artifact 300 from moving and may also index the calibration artifact 300 to a particular location and orientation on the workpiece movement mechanism 110.

In various implementations, the workpiece movement mechanism 110 is a rotary mechanism, such as a turntable, that rotates the calibration artifact 300 about a first (vertical) axis of rotation A1 (that is, clockwise and/or counterclockwise). In various implementations, the workpiece movement mechanism 110 includes multiple movement devices: for example, the workpiece movement mechanism 110 may include both a rotary device as well as a linear translation device. As another example, the workpiece movement mechanism 110 may include multiple rotary devices, each with a different axis of rotation.

In various implementations, the calibration artifact 300 is mounted on the workpiece movement mechanism 110 such that the calibration artifact 300 is offset from the first axis of rotation A1. In various implementations, the workpiece movement mechanism 110 is a kinematic seat. The kinematic seat may be capable of movement (e.g., rotation, indexing, etc.) between one or more positions, such that the kinematic seat is able to rotate the calibration artifact 300. In various implementations, the workpiece movement mechanism 110 is capable of moving (for example, rotating) the workpiece 12 during a machining operation performed by the manufacturing machine 100.

The spindle 120 may receive and retain the machine tool 130 and/or the secondary sensor 500. The spindle 120 may move (e.g., multi-axis movement) the machine tool 130 and/or the secondary sensor 500 relative to the workpiece 12, such that the machine tool 130 may manipulate the workpiece 12 or the secondary sensor 500 may measure the workpiece 12. In various implementations, the spindle 120 is stationary and the workpiece 12 is moved (e.g., by the workpiece movement mechanism 110) during manipulation by the machine tool 130 and/or measurement by the secondary sensor 500. In various implementations, the secondary sensor 500 is affixed on or within the spindle 120. The secondary sensor 500 may also be mounted anywhere on or within the manufacturing machine 100, such that the secondary sensor is fixed or moves along one or more axes while measuring the workpiece 12 within the scope of the present disclosure. In various implementations, the manufacturing machine 100 includes multiple spindles 120. A combination of the spindle 120 and/or the workpiece movement mechanism 110 may move (e.g., rotate, translate, etc.) the workpiece 12 during a machining operation performed by the manufacturing machine 100.

The machine tool 130 may be any tool capable of performing an operation (e.g., a machining operation) on the workpiece 12. In various implementations, the machine tool 130 is a removal tool capable of removing material from the workpiece 12. The machine tool 130 may be a drill bit, a reamer, an end mill, a face mill, a 3D printhead, a thru machining tool, a grinding tool, a polishing tool, an electrical discharge machining (EDM) tool, a diamond turning tool, a diamond cutting tool, a honing tool, etc.

The tool holder 140 may be configured to hold the machine tool 130, the secondary sensor 500, and any additional machine tools or secondary sensors in the manufacturing system 10.

The machine control module 150 may control the operation of the manufacturing machine 100 (e.g., the spindle 120 and/or the workpiece movement mechanism 110). For example, the machine control module 150 may receive and/or store code, such as computer-aided design/computer-aided manufacturing (CAD/CAM) code that instructs the manufacturing machine 100 on how to machine the workpiece 12. The code may be received from an external source or a source internal to the manufacturing machine 100. Additionally, the machine control module 150 may receive inputs (e.g., from the primary sensor 200, secondary sensor 500, and/or the closed-loop manufacturing control module 400).

In various implementations, instead of, or in addition to, receiving CAD/CAM code, the machine control module 150 may receive digital twin data, design intent data, or point cloud data. For example, a digital twin of a reference workpiece may be generated measuring the reference workpiece to create a digital representation of the reference workpiece. Future workpieces can be machined to match the reference workpiece based on the created digital twin data. In various implementations, the machine control module 150 receives a hybrid data set that instructs the manufacturing machine 100 on how to machine the workpiece 12. For example, the hybrid data set may include workpiece point cloud data (digital twin) and/or workpiece CAD/CAM data and/or any combination of multiple data sets, multiple CADs, digital twins, or any other combination. For example, the hybrid data set may include CAD data with stitched inserts of digital twins of the same workpiece.

Each of the primary sensors 200-1, 200-2, . . . , 200-n may be located within the manufacturing system 10, such that the primary sensors 200 measure at least a portion of the workpiece 12 independent of the movement of the manufacturing machine 100. For example, a primary sensor 200 may be connected to a stationary portion of the manufacturing machine 100 by an extension. In various implementations, the primary sensor 200 is not connected to the manufacturing machine 100. Each of the primary sensors 200-1, 200-2, . . . , 200-n may be located such that they measure at least a portion of the working volume of the manufacturing machine 100. The measurement performed by the primary sensor 200 may or may not overlap with the CAD/CAM code received by the manufacturing machine 100.

Each of the secondary sensors 500 may be located within the manufacturing system 10, such that the secondary sensors 500 measure at least a portion of the workpiece 12 during movement of the manufacturing machine 100. For example, the secondary sensor 500 may be mounted on a movable portion of the manufacturing machine 100 (e.g., the spindle 120 or the workpiece movement mechanism 110).

Each of the primary sensor 200 and/or the secondary sensor 500 may include one or more of a camera, a laser scanner, a tactile sensor, an x-ray sensor, a fringe projection system (e.g., a camera and a light projector), or any other contact- or non-contact type sensor. Further, each of the primary sensor 200 and/or the secondary sensor 500 may include multiple components, such as multiple cameras. In addition, each of the primary sensor 200 and/or the secondary sensor 500 may include an electromagnetic generator, such as an x-ray source or a light source. In implementations with multiple primary sensors 200, each primary sensor 200 may be the same or a different type of sensor from the other primary sensors 200. In implementations with multiple secondary sensors 500, each secondary sensor 500 may be the same or a different type of sensor from the other secondary sensors 500. Further, the primary sensors 200 and the secondary sensors 500 may be the same or a different type of sensor from each other.

At least one primary sensor 200-1 may define a second coordinate system CS2. The second coordinate system CS2 may be the same coordinate system or a separate coordinate system than the first coordinate system CS1. In various implementations, one or more of the primary sensors 200 monitor others of the primary sensors 200. For example, every one of the primary sensors 200 may be monitored by one or more of the other primary sensors 200. This monitoring may include taking—periodically and/or responsive to events—position measurements of the monitored primary sensor 200 without making physical contact. These measurements may be made based on received light, reflected high-frequency signals, etc. These position measurements may be communicated among the primary sensors 200 or may be communicated back to the closed-loop manufacturing control module 400.

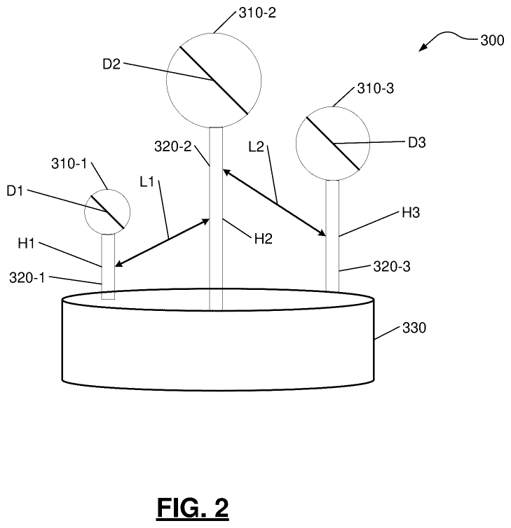

With reference to FIG. 2, the calibration artifact 300 may be any artifact of known and calibrated measurable properties. For example, the calibration artifact 300 may have a multi-feature design as shown in FIG. 2. In this regard, the calibration artifact 300 may include one or more spheres 310 mounted on one or more stems 320 extending from a base 330. The stems 320 may be of known and varied heights H1, H2, H3. The spheres may be of known and varied sizes (e.g., diameters D1, D2, D3). The distances between each sphere 310-1, 310-2, 310,3 of the one or more spheres 310 and each stem 320-1, 320-2, 320-3 of the one or more stems 320 may also be known (e.g., L1, L2). In various implementations, the calibration artifact 300 includes one or more machined features. In various implementations, the calibration artifact 300 is assembled from one or more components. During calibration of the one or more primary sensors 200, the calibration artifact 300 may be placed on the workpiece movement mechanism 110. While the calibration artifact 300 is shown and described as a having multiple (e.g., three) stems and spheres, the calibration artifact 300 may have any other suitable design within the scope of the present disclosure. For example, the calibration artifact 300 may be sized and shaped similar to the workpiece 12. In this regard, the calibration artifact 300 may represent the ideal dimensions of the workpiece 12, such that the calibration artifact 300 is an ideal reference part for the workpiece 12.

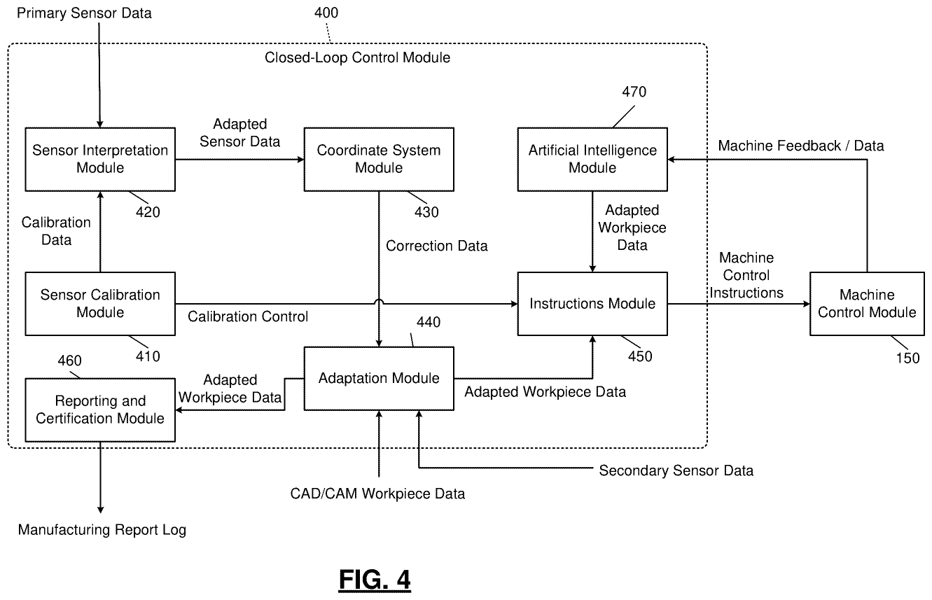

Referring now to FIG. 4, the closed-loop manufacturing control module 400 may include one or more modules, such that the closed-loop manufacturing control module 400 is capable of receiving sensor data (e.g., from the primary sensor 200 and/or the secondary sensor 500) and workpiece data (e.g., CAD/CAM code, digital twin data, etc.), adapting the workpiece data, and providing instructions to the manufacturing machine 100 (e.g., the machine control module 150) to perform manufacturing operations on the workpiece 12.

The closed-loop manufacturing control module 400 may include a sensor calibration module 410, a sensor interpretation module 420, a coordinate system module 430, an adaptation module 440, an instructions module 450, and a reporting and certification module 460.

The sensor calibration module 410 may provide calibration data to the sensor interpretation module 420 based on data received by the sensor calibration module 410 of the measurement of the calibration artifact 300 with the primary sensor 200.

The sensor interpretation module 420 may receive the calibration data from the sensor calibration module 410 and primary sensor data (e.g., from measuring the workpiece 12 with the primary sensor 200). The sensor interpretation module 420 may adapt (e.g., correct) the primary sensor data based on the calibration data. The sensor interpretation module 420 may send the adapted sensor data to the coordinate system module 430.

The coordinate system module 430 may receive the adapted sensor data from the sensor interpretation module 420 and data from the manufacturing machine 100 (e.g., CAD/CAM code and/or secondary sensor data). The data from the manufacturing machine 100 may include the coordinate system CS1 of the manufacturing machine 100. For example, when the manufacturing machine 100 machines a feature onto the workpiece 12, evidence of the coordinate system CS1 of the manufacturing machine 100 is left on workpiece 12 in the machined feature. In other words, all of the errors associated with the manufacturing machine 100 are now encoded into the workpiece 12. When the secondary sensor data from measuring the feature or the CAD/CAM code used to machine the feature are received by the coordinate system module 430, the coordinate system module 430 knows the coordinate system CS1 of the manufacturing machine 100. The adapted sensor data, which includes the data from measuring the machined feature, includes the coordinate system CS2 of the primary sensor 200. The coordinate system module 430 may tie together the coordinate systems CS1, CS2 of the primary sensor 200 and the manufacturing machine 100 based on the adapted sensor data and the data from the manufacturing machine 100. Tying together the coordinate systems CS1, CS2 may include determining correction data based on a difference between the adapted sensor data and the data from the manufacturing machine 100. In this regard, the coordinate systems CS1, CS2 of the manufacturing machine 100 and the primary sensor 200 are tied through the workpiece 12 (e.g., through the measurements of the workpiece 12). At this point, the workpiece 12 becomes an artifact that combines coordinate systems CS1, CS2, machine errors, and machining errors. The coordinate system module 430 may send the correction data to the adaptation module 440.

The adaptation module 440 may receive workpiece data (e.g., CAD/CAM code, digital twin data, or any combination of any workpiece data combined in a hybrid form) from an external source (e.g., an operator of the manufacturing machine 100, a digital system, a digital automation system, etc.) and the correction data from the coordinate system module 430. The adaptation module 440 may adapt (e.g., update, correct, etc.) the workpiece data based on the correction data. In various implementations, the correction data includes correction information for only a portion of the workpiece data. In these implementations, the correction information for the remaining workpiece data is calculated by interpolation, extrapolation, or other mathematical, or advanced means, such as through the use of an Artificial Intelligence (AI) model. For example, the AI model may be a generative AI model. The adaptation module 440 may send the adapted workpiece data to the instructions module 450 and/or the reporting and certification module 460. In various implementations, the adaptation module 440 processes the workpiece data and the correction data and sends the workpiece data and the correction data to the source of the CAD/CAM code to generate the adapted workpiece data. In various implementations, the workpiece data and the correction data are sent to a third-party to update the CAD/CAM code based on the workpiece data and the correction data.

The instructions module 450 may receive the adapted workpiece data from the adaptation module 440 and send machine control instructions to the machine control module 150 instructing the manufacturing machine 100 to machine the workpiece 12 based on the adapted workpiece data.

The reporting and certification module 460 may receive the adapted workpiece data from the adaptation module 440. The reporting and certification module 460 may generate a log based on the adapted workpiece data. The log may include documentation (e.g., a list of) of the differences between the initial CAD/CAM code and the adapted workpiece data. The log may be sent back to the manufacturing machine 100. The log may be used for part certification, as an input for a digital twin system, as an input for artificial intelligence (AI) models, and/or as data for further manufacturing optimization.

In various implementations, the closed-loop manufacturing control module 400 may include an artificial intelligence (AI) module 470. The AI module 470 may learn on feedback and/or data received from the manufacturing machine 100 (e.g., the machine control module 150). In other words, the AI module 470 may learn on the knowledge gained from the manufacturing method described herein. The AI module 470 may model and predict the behavior of the manufacturing machine 100 to produce all the necessary corrections to the manufacturing machine 100 in order to accurately machine the workpiece 12. In this regard, over time, the AI module 470 may eliminate the need to use the primary sensor 200 and/or the secondary sensor 500 to correct the manufacturing machine 100. The AI module 470 may use any combination of any existing or future AI technologies and data inputs to model and predict the behavior of the manufacturing machine 100.

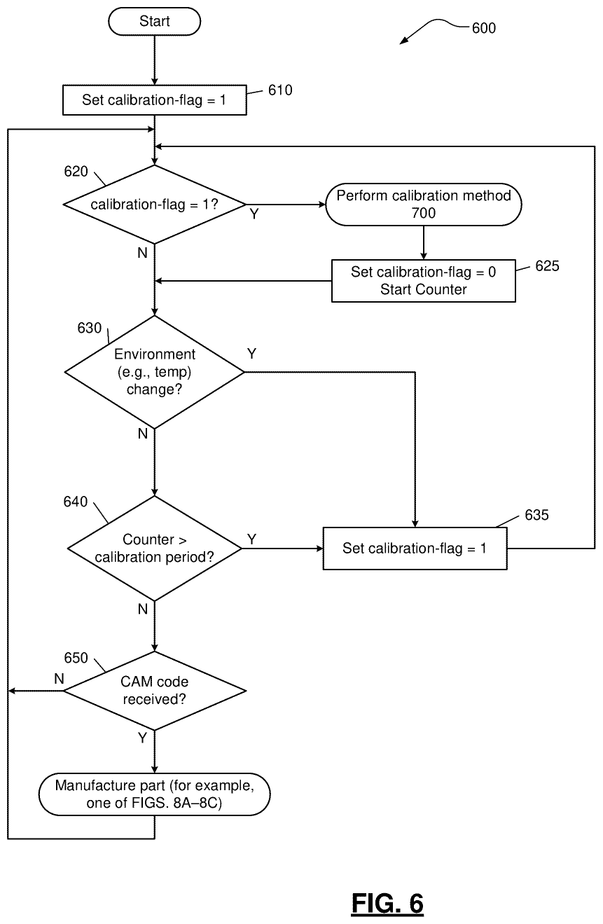

Referring now to FIGS. 6-8C, a method 600 of operating a manufacturing system (e.g., the manufacturing system 10) will now be described in more detail below.

The method 600 may begin by checking if the primary sensor 200 is calibrated. For example, the primary sensor 200 may be associated with a calibration flag. The calibration flag may read 0 if the primary sensor 200 is calibrated and the calibration flag may read 1 if the primary sensor 200 needs to be (re-)calibrated.

In a step 610, the calibration flag is initially set to 1 (needs to be calibrated). This may trigger the primary sensor 200 to undergo an initial calibration.

In a step 620, the manufacturing machine 100 (e.g., machine control module 150) may check the calibration flag. If the calibration flag is set to 1, a calibration method 700 may be performed on the primary sensor 200. The calibration method 700 will be described in more detail below. Upon completing the calibration method 700, the manufacturing machine 100 (e.g., machine control module 150) may set the calibration flag to 0 in a step 625. In various implementations, the manufacturing machine 100 (e.g., machine control module 150) may start a counter at step 625. In various implementations, the counter counts the amount of time that has elapsed. In various implementations, the counter counts the number of workpieces manufactured or machining operations performed by the manufacturing machine 100. If the calibration flag is set to 0, then the method 600 may proceed to step 630.

In a step 630, the manufacturing machine 100 (e.g., machine control module 150) may check if any environmental changes have occurred in the manufacturing system 10 since the last time the calibration method 700 was performed. For example, environmental changes may include changes in temperature, humidity, pressure, etc. If environmental changes have occurred, the calibration flag may be set to 1 in a step 635. From step 635, the method 600 may loop back around to step 620 to check the calibration flag and perform the calibration method 700 if necessary. If no environmental changes have occurred, the method 600 may proceed to step 640.

In a step 640, the manufacturing machine 100 (e.g., machine control module 150) may check if the counter, started in step 625, has exceeded a calibration period. The calibration period may be a set period of time after which it is necessary to (re-)calibrate the primary sensor 200. For example, the calibration period may be hourly, the length of a shift (e.g., 8 or 12 hours), a day, a week, a month, a year, etc. In various implementations, the calibration period is based on the number of workpieces put through the manufacturing machine 100. For example, the calibration period may be one workpiece or a set number of workpieces (e.g., 5, 10, 50, 100, 1,000, etc.). If highly precise tolerances are required, the calibration period may be a single machining operation.

If the counter has exceeded the calibration period, the calibration flag may be set to 1 in step 635. From step 635, the method 600 may loop back around to step 620 to check the calibration flag and perform the calibration method 700 if necessary. If the counter has not exceeded the calibration period, the method 600 may proceed to step 650.

In a step 650, the manufacturing machine 100 (e.g., the machine control module 150) checks if it has received code (e.g., CAD/CAM code) to control the operation of the manufacturing machine 100. In various implementations, the manufacturing machine 100 actively searches for code (e.g., CAD/CAM code) that can be downloaded to control the operation of the manufacturing machine 100. Specifically, the CAD/CAM code may control one or more of the workpiece movement mechanism 110, the one or more spindles 120, or the machine tool 130. The CAD/CAM code may define one or more machining operations that the manufacturing machine 100 may perform on the workpiece 12. If the manufacturing machine 100 has not received CAD/CAM code, the method loops back to step 620 and the manufacturing machine 100 remains in a waiting state until CAD/CAM code is received. Once the manufacturing machine 100 receives the CAD/CAM code, the manufacturing machine 100 may begin manipulating the workpiece 12 (e.g., performing an additive, subtractive, or hybrid manufacturing operation on the workpiece 12) according to one of the manufacturing methods 800, 800a, 800b.

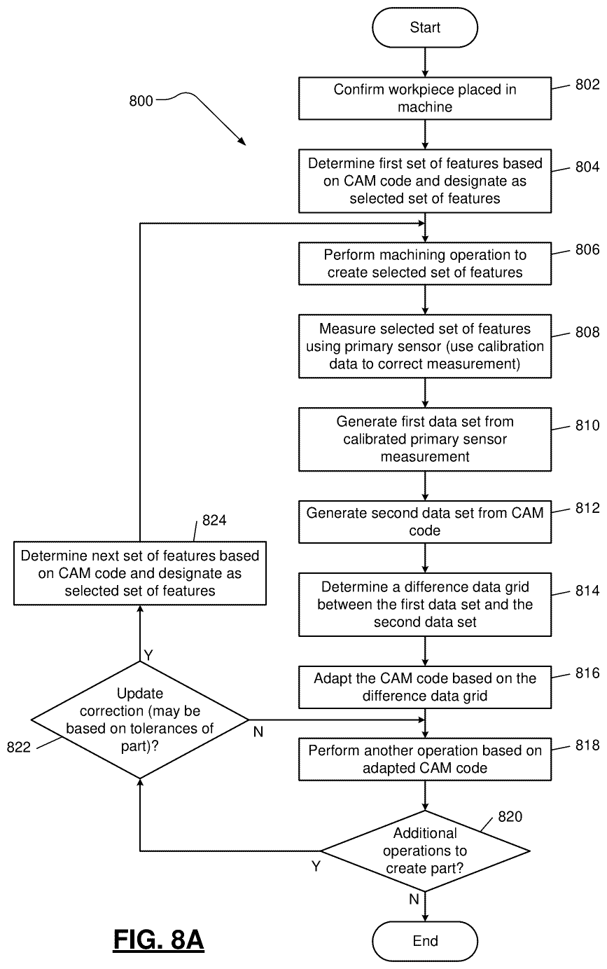

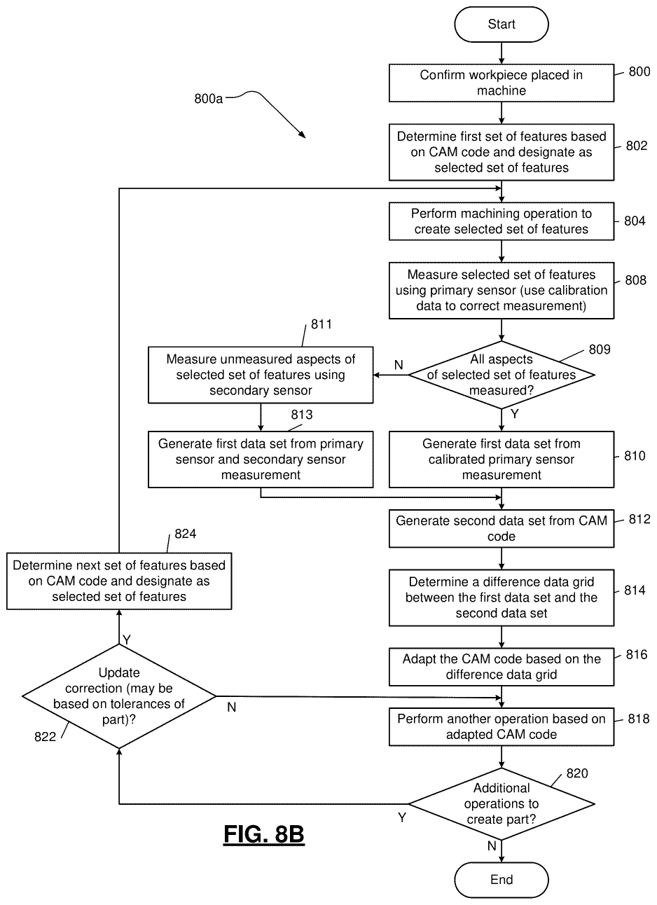

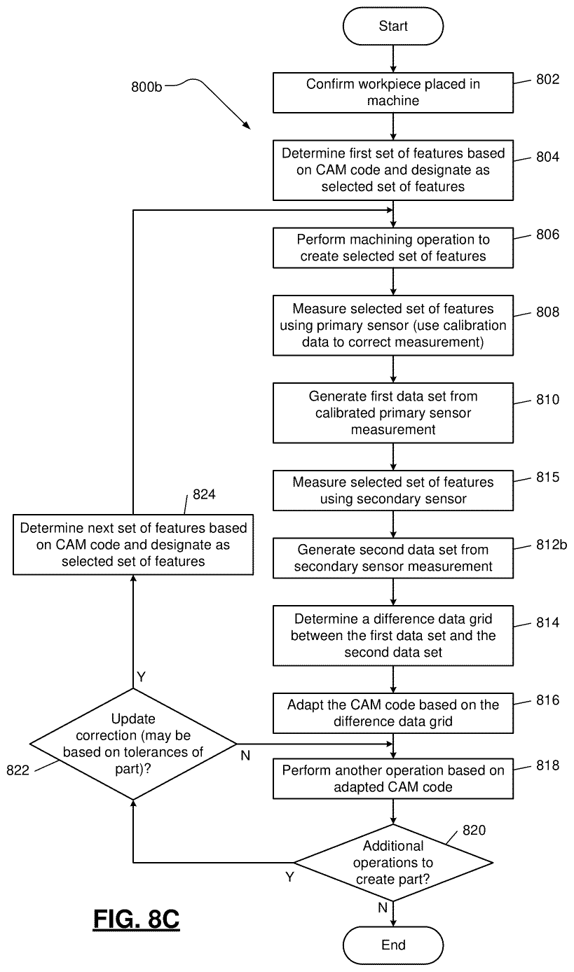

With reference to FIGS. 8A-8C, one or more manufacturing methods 800, 800a, 800b will be described.

In a step 802, a workpiece 12 may be placed in the manufacturing machine 100 (e.g., in the workpiece movement mechanism 110) and the manufacturing machine 100 (e.g., the machine control module 150) may confirm that the workpiece 12 is placed in the manufacturing machine 100. For example, the workpiece 12 may be placed in the manufacturing machine 100 by an operator or a robot. In various implementations, the workpiece 12 is cut from a stock of material. In various implementations, the workpiece 12 is one or more parts that will be cut away from a base of a stock of material at the end of a machining operation. The workpiece 12 may be placed within the working space 160 of the manufacturing machine 100.

In a step 804, the manufacturing machine 100 (e.g., the machine control module 150) may determine a first set of features 14 (FIG. 3B) to create on the workpiece 12. The first set of features 14 may be determined based on code (e.g., CAD/CAM code) received by the manufacturing machine 100 (e.g., the machine control module 150). In various implementations, the first set of features 14 is a plurality of features 14. In various implementations, the first set of features 14 is a single feature 14. The first set of features 14 may be designated as the selected set of features 14.

In a step 806, the manufacturing machine 100 may perform a first machining operation on the workpiece 12 to create the selected feature(s) 14. For example, the manufacturing machine 100 may use the machine tool 130 to cut a surface on or drill a hole into the workpiece 12. The manufacturing machine 100 may receive instructions to perform the first machining operation from the machining operations defined in the CAD/CAM code.

In a step 808, at least a portion of the selected set of features 14 may be measured with the primary sensor 200. During measurement with the primary sensor 200, only the workpiece movement mechanism 110 may remain operational (e.g., capable of movement), while the other axes of the manufacturing machine 100 (e.g., the spindle 120 and other movable parts of the manufacturing machine 100) remain stationary. The primary sensor 200 may measure each feature of the selected set of features 14 in sequence or in parallel. In various implementations, the measurement with the primary sensor may be corrected based on the calibration data generated during the calibration method 700.

In various implementations, a plurality of primary sensors 200 are used to measure the selected set of features 14. The plurality of primary sensors 200 may measure the workpiece 12 from multiple angles, such that multiple surfaces of the workpiece 12 are measured simultaneously. In various implementations, the workpiece movement mechanism 110 rotates the workpiece 12 during measurement with the plurality of primary sensors 200. In various implementations, the workpiece movement mechanism 110 remains in a locked position during the measurement of the workpiece 12. In this regard, the workpiece movement mechanism 110 may not move (e.g., rotate) the workpiece 12 during measurement with the plurality of primary sensors 200. In various implementations, the workpiece movement mechanism 110 may be eliminated entirely and the workpiece 12 may simply be placed on a stationary portion of the manufacturing machine 100 within the working space 160 of the manufacturing machine 100. Since the coordinate systems of each primary sensor 200 of the plurality of primary sensors 200 are tied together through the calibration process (described in more detail below), the measurements from the plurality of primary sensors 200 can be combined to generate the first data set.

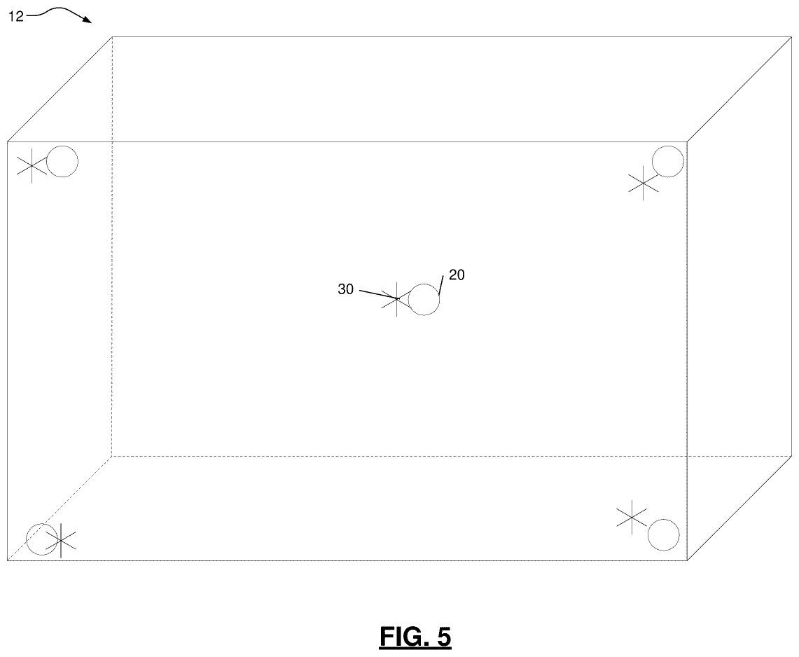

In a step 810, a first data set 20 (FIG. 5) is generated. The first data set 20 may represent one or more measured points, lines, surfaces, features, etc. of the workpiece 12. The first data set 20 may be generated based on the measurement with the primary sensor 200.

In various implementations (e.g., the method 800a; FIG. 8B), the method 800a includes a step 809 between steps 808 and 810. In step 809, the manufacturing machine 100 (e.g., the machine control module 150) checks if all the features of the selected set of features 14 have been captured by the measurement with the primary sensor 200. If all the features of the selected set of features 14 have been captured by the measurement with the primary sensor 200, the method proceeds to step 810a. If less than of all of the features of the selected set of features 14 have been captured by the measurement with the primary sensor 200, the method proceeds to step 811. For example, at least a portion of the selected set of features 14 may be hidden from the view of the one or more primary sensors 200. In various implementations, the hidden portion of the selected set of features 14 is mathematically derived from the measurement of the non-hidden portion of the selected set of features 14. In various implementations, the hidden portion of the selected set of features 14 is measured with the one or more secondary sensors 500.

In various implementations (FIG. 8B), in a step 811, the unmeasured portion of the selected set of features 14 are measured with the secondary sensor 500. The measurement with the primary sensor 200 may be combined with the measurement with the secondary sensor 500. In these implementations, in a step 813, the first data set 20 is generated based on the combined measurements with the primary sensor 200 and the secondary sensor 500.

In a step 812, a second data set 30 (FIG. 5) may be gathered. For example, the second data set 30 may be generated or retrieved from the CAD/CAM code (e.g., the portion of the CAD/CAM code that controlled the first machining operation). In various implementations (FIG. 8C), the second data set 30 is generated from a measurement of the selected set of features 14 with the secondary sensor 500. In these implementations, the measurement of the selected set of features with the secondary sensor 500 is performed in a step 815 prior to the step 812b. The second data set 30 may represent one or more measured points, lines, surfaces, features, etc. of the workpiece 12. The first data set 20 and the second data set 30 may at least partially overlap. In various implementations, the first data set 20 and the second data set 30 measure the exact same points, lines, surfaces, features, etc. of the workpiece 12.

During measurement with the secondary sensor 500, the secondary sensor 500 and/or the workpiece 12 is moved by the manufacturing machine 100 (e.g., the spindle 120, the workpiece movement mechanism 110, or another movable part of the manufacturing machine 100) in a motion substantially similar (or identical to) the motion of the manufacturing machine 100 while generating the selected set of features 14. In various implementations, a combination of CAD/CAM code and measurement with the secondary sensor 500 is used to generate the second data set 30.

In a step 814, a difference between the first and second data sets 20, 30 is determined (e.g., by the closed-loop manufacturing control module 400). The difference between the first and second data sets 20, 30 may encapsulate all of the errors associated with manufacturing system 10. The errors may include, machine errors, machining errors, environmental errors, part elastic and plastic deformation errors, tool chatter or marks, and any other errors associated with the manufacturing system 10.

In a step 816, the CAD/CAM code may be adapted (e.g., updated, corrected, modified, etc.) based on the difference between the first and second data sets 20, 30. In various implementations, the CAD/CAM code is directly adapted based on the difference between the first and second data sets 20, 30. In various implementations, further corrections are made to the difference between the first and second data sets 20, 30 based on other known changes and the CAD/CAM code is adapted based on (i) the difference between the first and second data sets 20, 30, and (ii) the further corrections.

In a step 818, a portion of the adapted CAD/CAM data may be executed by the manufacturing machine 100 (e.g., the machine control module 150), which causes the manufacturing machine 100 to continue machining the workpiece 12. In various implementations, a log (e.g., a quality report) is generated based on the adaptations made to the CAD/CAM code. The log may be used for part certification, as an input for a digital twin system, as an input for artificial intelligence (AI) models, and/or as data for further manufacturing optimization. In various implementations, a report is output based on the log.

In a step 820, the manufacturing machine 100 (e.g., the machine control module 150) checks if additional machining operations are needed to create a part out of the workpiece 12. If no additional machining operations are necessary, the method 800, 800a, 800b ends.

If additional machining operations are necessary, the manufacturing machine 100 (e.g., the machine control module 150) checks if the CAD/CAM code correction needs to be updated in a step 822. For example, the CAD/CAM code correction may need to be updated if a calibration period for the manufacturing machine 100 has been exceeded. For example, the calibration period may be hourly, the length of a shift (e.g., 8 or 12 hours), a day, a week, a month, a year, etc. In various implementations, the calibration period is based on the number of workpieces put through the manufacturing machine 100. For example, the calibration period may be one workpiece or a set number of workpieces (e.g., 5, 10, 50, 100, 1,000, etc.). If highly precise tolerances are required, the calibration period may be a single machining operation. In various implementations, the CAD/CAM code correction may need to be updated if any environmental changes have occurred in the manufacturing system 10 since the previous machining operation occurred. For example, environmental changes may include changes in temperature, humidity, pressure, etc.

If the CAD/CAM code correction does not need to be updated, then the method 800, 800a, 800b loops back around to step 818 and another portion of the adapted CAD/CAM data may be executed by the manufacturing machine 100 (e.g., the machine control module 150) to continue machining the workpiece 12. If the CAD/CAM code correction needs to be updated, then, in a step 824, the manufacturing machine 100 (e.g., the machine control module 150) determines a second set of features 16 (FIG. 3C) to create on the workpiece 12. The second set of features 16 may be determined in a similar fashion to the first set of features 14. The method 800, 800a, 800b then proceeds to step 806 to machine the second set of features 16 and repeat the method 800, 800a, 800b. As the method 800, 800a, 800b is repeated, the working space 160 of the manufacturing machine 100 may be re-calibrated and the CAD/CAM code may be re-adapted based on the re-calibration of the working space 160 in the steps 808-816.

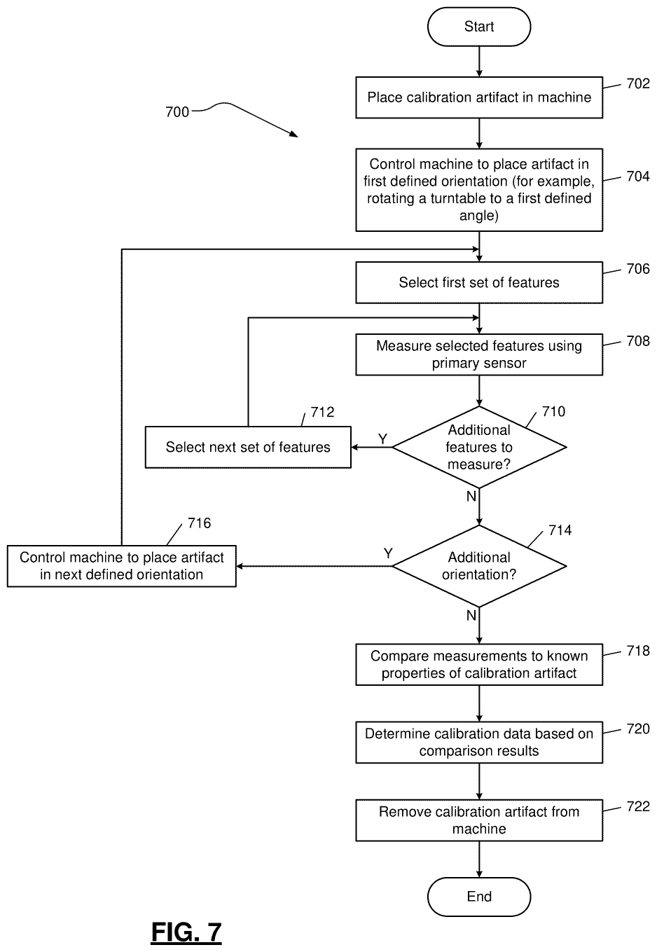

With reference to FIG. 7, a method of calibrating the primary sensor 200 will now be described in more detail below. It will be appreciated that the primary sensor 200 may be pre-calibrated within the scope of the present disclosure. In this regard, it may not be necessary to calibrate the primary sensor 200 using the method 700 described below. Additionally, even if the primary sensor 200 is pre-calibrated, the calibration method 700 described below may be performed to provide additional calibration of the primary sensor 200 or to completely recalibrate the primary sensor 200. The method 700 may also be used to calibrate the secondary sensor 500 within the scope of the present disclosure.

In a step 702, the calibration artifact 300 is placed in the manufacturing machine 100 (e.g., within the working space 160). For example, the calibration artifact 300 may be placed in the workpiece movement mechanism 110 of the manufacturing machine 100.

In a step 704, the manufacturing machine 100 is controlled (e.g., by the machine control module 150) to place the calibration artifact 300 in a first defined orientation. For example, the workpiece movement mechanism 110 may rotate the calibration artifact 300 to a first defined angle.

In a step 706, a first set of features of the calibration artifact 300 are selected to be measured by the primary sensor 200. For example, the first set of features may include one or more of the stems 320 or spheres 310.

In a step 708, the primary sensor 200 measures the first set of features of the calibration artifact 300.

In a step 710, the method 700 checks if additional features of the calibration artifact 300 need to be measured during calibration. If so, in a step 712, a second set of features of the calibration artifact 300 are selected to be measured by the primary sensor 200. For example, the second set of features may include one or more of the stems 320 or spheres 310. In various implementations, the first and second set of features at least partially overlap. In various implementations, there is no overlap between the first and second set of features. The method 700 may then loop back to step 708 to measure the second set of features using the primary sensor 200.

In a step 712, the method 700 checks if additional orientations of the calibration artifact 300 need to be measured during calibration. If so, then in a step 716, the manufacturing machine 100 (e.g., the workpiece movement mechanism 110) may then move (e.g., rotate) the calibration artifact 300 to a second defined orientation, while the primary sensor 200 measures the calibration artifact 300. For example, the workpiece movement mechanism 110 may rotate the calibration artifact 300 continuously, move in step from a first position to a second position, overlap positions, stop rotating, or any combination of such movements. In implementations that utilize a kinematic plate, the kinematic plate may move (e.g., rotate) the calibration artifact 300 between one or more kinematic locations to allow rotational clocking. The primary sensor 200 may measure the first and/or second set of features of the calibration artifact 300. The primary sensor 200 may perform measurements during movement of the calibration artifact 300 and/or after the calibration artifact 300 is moved to the second defined orientation. In various implementations, during movement of the calibration artifact 300, the spindle 120 is locked in a non-moving position. During this step, the second coordinate system CS2 may be established.

In a step 718, the measurements from the primary sensor 200 may be compared to the known values (e.g., D1, H1, L1, etc.) of the calibration artifact 300. In a step 720, a calibration data set is generated based on the results of the comparison of the measurements from the primary sensor 200 and the known values (e.g., D1, H1, L1, etc.) of the calibration artifact 300. The primary sensor 200 may be calibrated based on the calibration data set. Calibration of the primary sensor 200 by this method may also correct any errors associated with the workpiece movement mechanism 110.

In a step 722, the calibration artifact 300 may be removed from the manufacturing machine 100 (e.g., by an operator) and the calibration method 700 is complete.

In various implementations, the calibration method 700 may be performed multiple times to generate multiple calibration data sets. A master calibration data set may be generated from the multiple calibration data sets (e.g., by averaging, or other more advanced calculations) and the primary sensor 200 may be calibrated based on the master calibration data set.

In various implementations, a plurality of primary sensors 200 are disposed in the space around the manufacturing machine 100. In this regard, the calibration artifact 300 and/or workpiece 12 may be measured from multiple angles, such that multiple surfaces of the calibration artifact 300 and/or workpiece 12 may be measured simultaneously. Additionally, in various implementations, a single primary sensor 200 is capable of measuring multiple surfaces of the calibration artifact 300 and/or workpiece 12 simultaneously. In these implementations, the plurality of primary sensors 200 may measure the calibration artifact 300 as described in the calibration method 700 above. In various implementations, the workpiece movement mechanism 110 may remain in a locked position during the measurement of the calibration artifact 300 with the plurality of primary sensors 200. In this regard, the workpiece movement mechanism 110 may not move (e.g., rotate) the calibration artifact 300 during measurement with the plurality of primary sensors 200. In various implementations, the workpiece movement mechanism 110 is not locked during the measurement of the calibration artifact 300 with the plurality of primary sensors 200. In various implementations, the workpiece movement mechanism 110 may be eliminated entirely and the calibration artifact 300 may simply be placed on a stationary portion of the manufacturing machine 100 within the working space 160 of the manufacturing machine 100.

Each primary sensor 200 of the plurality of primary sensors 200 may define its own coordinate system. During the calibration method 700, the multiple coordinate systems are tied together through the measurement of the calibration artifact 300.

### EXAMPLE IMPLEMENTATION

An example implementation of the present disclosure follows:
1. To start, a CAM code is provided.
2. In various implementations, calibration of the secondary sensor 500 may be performed by the CNC providers. Calibration of the secondary sensor 500 may be done outside the manufacturing machine 100 (in various implementations, the secondary sensor 500 can instead or also be calibrated on the machine 100).
3. In various implementations, the primary sensor 200 may also be calibrated outside of the manufacturing machine 100. In various implementations, calibration of the primary sensors is done in the same way as the secondary sensor 500, but may also be done in a different unique way from the secondary sensor 500.
4. The primary sensor 200 is mounted somewhere within or outside the manufacturing machine's envelope. For example, the primary sensor 200 can be mounted to the machine frame or, depending on the machine combination, stationed outside of the machine. In various implementations, the machine frame mounting location of the primary sensor 200 may produce more stable results, so the primary sensor 200 may be mounted to the machine frame/base (e.g., with some extension, etc., to properly position the primary sensor 200). In this regard, the primary sensor 200 looks from the side of the workpiece 12 mounted on the rotary axis of the manufacturing machine 100 (e.g., the workpiece movement mechanism 110).
5. What needs to be calibrated is the working space 160 of the manufacturing machine 100, so that the working space 160 of the manufacturing machine 100 can be defined, and the coordinate system CS2 of the primary sensor 200 can be matched to the coordinate system CS1 of the workpiece movement mechanism 110 (e.g., the rotary axis or the kinematic plate). In this regard, the 3D volume is calibrated (the volume that is created and affected by the machine tool 130, so there is imaginary space where the workpiece 12 is cut). To calibrate the 3D volume, a calibration artifact 300 is placed on the rotary axis (the axis to which normally the workpiece 12 is mounted), and the primary sensor 200 measures the calibration artifact 300. This provides additional calibration of spindle errors and tight calibration of the primary sensor 200 itself (additional corrections on top of what it came with). In various implementations, this step can happen every time or once every period, such as a day, week, month, or year, or any interval that will be determined by the machine's repeatability and all other environmental and machine factors. Additionally, the manufacturing machine 100 may go through usual prep work like aligning the cutting tool and the typical prep work prior to the machining operation.
6. A portion of a CAM code is executed to see a surface that was machined by the manufacturing machine 100 setup as is. In various implementations, the surface may be the actually intended final shape of the workpiece 12. In various implementations, the surface may be a temporary (as later will be machined away or stay as finished surface) test surface such as flats, openings, steps, etc. that are cut on the workpiece 12 (the workpiece 12 means the very part that is being machined). In various implementations, a number of cuts and locations will be determined initially. For example, simulation software can be used to determine where to cut first on the workpiece 12 to produce the best references. In a simple implementation, the initial surface could be machined by execution of one or a few passes of the original CAM code.
7. After the cuts are made, the workpiece 12 is measured by the primary sensor 200 (or sensors if there are more than one). Since the primary sensor 200 is calibrated, the calibration of the primary sensor 200 is used to accurately define the exact locations in 3D space of the measured surface or point, points, etc. In various implementations, a workpiece movement mechanism 110 rotates the workpiece 12 to new positions to show to the primary sensor 200 each surface used as a reference (e.g., a cube might have four workpiece movement mechanism 110 turns, but any other shapes can have many more or less). Therefore, the primary sensor 200 is used to calibrate the precise location of the reference surfaces. In various implementations, the reference surfaces can be virtually defined as fiducial points, sets of point surfaces, or volumes depending on the type of primary sensor 200 used. In this regard, the very workpiece 12 that is being machined becomes an artifact for the moment in time (after the workpiece 12 was measured with the primary sensor 200 as it is now known precisely what the location is of each reference surface location in 3D space). As a result, the machine coordinate system CS1 and the primary sensor coordinate system CS2 are combined, as the machined features represent the evidence of the machine coordinate system CS1. In various implementations, the machine axis remains locked or stopped as this step is performed.
8. In various implementations, with the secondary sensor 500, the same locations on the workpiece 12 are measured as those measured with the primary sensor 200. However, during measurement with the secondary sensor 500, all axes of the manufacturing machine 100 may move (as they would with CAM code execution). The secondary sensor 500 may be placed within the spindle 120 of the manufacturing machine 100. In various implementations, the secondary sensor 500 may be placed in different locations as long as the secondary sensor 500 can measure the workpiece 12 while the manufacturing machine 100 moves the workpiece 12 around. In various implementations, the CAD/CAM data may be used instead of or in addition to the measurements gathered by the secondary sensor 500.
9. After steps 7 and 8, there are two sets of data; the one from the primary sensor 200 is a reference data set, and the one from the secondary sensor 500 is the CNC-viewed data set. The difference between those two data set defines a delta (the sources of the delta are combined from geometric errors, temp drifts, tool and part dynamics, softer material may provide different outcomes than harder materials, etc.). This delta may be applied to the CAM code to correct the entire code. In various implementations, the delta represents points in 3D space that define machine behavior. In various implementations, every feature of interest (e.g., surface, point, volume, etc.) of the workpiece 12 will be corrected through interpolation or extrapolation, as is done with modern coordinate measuring machines (CMMs). In this regard, measuring every feature of the workpiece 12 may not be necessary, as their corrections can be derived from the data obtained from steps 7 and 8. For example, a CMM might have reference points collected every 50 mm or more or less, and from this, the detailed correction for every location within the resolution of the CMM is derived; a similar principle is used here. The more reference points, the tighter the correction may be. The closer the reference points are, the more nonlinear behavior can be corrected and captured. In various implementations, with dense points, additional detail, such as chatter, can be observed. In this regard, point density defines the resolution.
10. The new CAM code (corrected) is executed, and the part is machined to the end.
11. In various implementations, if there is serial production or a very stable manufacturing machine 100, steps 7-9 are only done periodically, as the manufacturing machine 100 might stay corrected for an extended period of time. In various implementations, if new materials are machined or tight tolerances are made, or new cutting tools used etc., a new step 7-9 process may be performed. In various implementations, if the workpiece 12 is very precise, steps 7-9 may be done multiple times within one part manufacturing. In other words, how often the correction is performed depends on the final need and level of precision required of the workpiece 12.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Additionally, one or more method steps may be skipped without departing from the scope of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, physical components, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements.

However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In various implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In various implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave).

Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

### CLAUSES

Various example embodiments of the invention are described in the following clauses.

Clause 1: A method comprising:
receiving data associated with a workpiece mounted in a manufacturing machine;
following performance of a first machining operation on the workpiece by the manufacturing machine that generates a first feature on the workpiece, gathering a first data set;
gathering a second data set;
determining a difference data set based on differences between the first data set and the second data set;
modifying the data based on the difference data set; and
causing the manufacturing machine to use the modified data in performing an additional machining operation on the workpiece.

Clause 2: The method of clause 1 wherein modifying the data includes generating a modified data set based on the difference data set, and the manufacturing machine uses the modified data set to perform the additional machining operation.

Clause 3: The method of clause 1 further comprising predicting, by an artificial intelligence (AI) module, a behavior of the manufacturing machine based on at least one of: feedback or data received from the manufacturing machine.

Clause 4: The method of clause 1 wherein the data includes at least one of: computer-aided manufacturing (CAM) code, computer-aided design (CAD) code, digital twin data, design intent data, or point cloud data.

Clause 5: The method of clause 1 wherein gathering the first data set includes measuring the first feature using a primary sensor.

Clause 6: The method of clause 1 wherein gathering the first data set includes measuring the first feature using a primary sensor and a secondary sensor.

Clause 7: The method of clause 1 wherein gathering the second data set includes retrieving the second data set from the data.

Clause 8: The method of clause 1 wherein gathering the second data set includes measuring the first feature using a secondary sensor.

Clause 9: The method of clause 1 further comprising updating a log based on the difference data set.

Clause 10: The method of clause 9 further comprising outputting a report based on the log.

Clause 11: The method of clause 9 further comprising updating a digital twin based on the log

Clause 12: The method of clause 5 wherein the primary sensor includes a camera.

Clause 13: The method of clause 5 wherein the primary sensor includes a plurality of cameras.

Clause 14: The method of clause 5 wherein the primary sensor is a contact sensor.

Clause 15: The method of clause 14 wherein the contact sensor is a tactile sensor.

Clause 16: The method of clause 5 wherein the primary sensor is a non-contact sensor.

Clause 17: The method of clause 16 wherein the non-contact sensor includes at least one of a camera, a laser scanner, or an x-ray sensor.

Clause 18: The method of clause 8 wherein the secondary sensor is a contact sensor.

Clause 19: The method of clause 18, wherein the contact sensor is a tactile sensor.

Clause 20: The method of clause 8 wherein the secondary sensor is a non-contact sensor.

Clause 21: The method of clause 20 wherein the non-contact sensor includes at least one of a camera, a laser scanner, or an x-ray sensor.

Clause 22: The method of clause 1 wherein the manufacturing machine is a computer numerical control (CNC) machine.

Clause 23: The method of clause 1 wherein the manufacturing machine is one or more robots.

Clause 24: The method of clause 1 wherein the additional machining operation at least partially removes the first feature from the workpiece.

Clause 25: The method of clause 1 wherein the additional machining operation machines a portion of the workpiece separate from the first feature.

Clause 26: The method of clause 8 wherein:
the manufacturing machine includes a spindle configured to retain a removal tool used in the first machining operation, and
the spindle is also configured to retain the secondary sensor.

Clause 27: The method of clause 26 wherein the removal tool is at least one of: an end mill, a thru machining tool, a drill bit, a grinding tool, a polishing tool, an electrical discharge machining (EDM) tool, a diamond turning tool, a diamond cutting tool or a honing tool.

Clause 28: The method of clause 26 wherein the removal tool is any tool capable of removing material from the workpiece.

Clause 29: The method of clause 8 wherein:
the manufacturing machine includes a spindle that retains a removal tool used in the first machining operation, and
the secondary sensor is affixed to the spindle and remains affixed to the spindle while the first machining operation is performed.

Clause 30: The method of clause 1 wherein the manufacturing machine includes a workpiece movement mechanism configured to receive the workpiece.

Clause 31: The method of clause 30 wherein the workpiece movement mechanism is a rotary mechanism configured to rotate the workpiece around a vertical axis.

Clause 32: The method of clause 30 wherein the workpiece movement mechanism is a kinematic seat.

Clause 33: The method of clause 1 further comprising:
measuring a calibration artifact mounted in the manufacturing machine using a primary sensor to generate a calibration data set; and
calibrating the primary sensor based on known properties of the calibration artifact, a known mounting location of the calibration artifact with respect to the manufacturing machine, and the calibration data set.

Clause 34: The method of clause 5 further comprising: aligning a coordinate system of the manufacturing machine with a coordinate system of the primary sensor.

Clause 35: The method of clause 34 wherein the coordinate system of the manufacturing machine is a coordinate system associated with a workpiece movement mechanism of the manufacturing machine.

Clause 36: The method of clause 34 wherein the coordinate system of the manufacturing machine is a coordinate system associated with a spindle of the manufacturing machine.

Clause 37: The method of clause 1, wherein:
the workpiece is mounted on a stationary portion of the manufacturing machine,
gathering the first data set includes measuring the first feature using a plurality of primary sensors,
each primary sensors of the plurality of primary sensors performs a respective measurement of the first feature from a respective angle, and
gathering the first data set includes combining the respective measurements from each primary sensor of the plurality of primary sensors to generate the first data set.

Clause 38: The method of clause 37 further comprising:
measuring a calibration artifact mounted on the stationary portion of the manufacturing machine with each primary sensor of the plurality of primary sensors to generate a calibration data set, wherein:
   each primary sensor of the plurality of primary sensors generates a respective calibration measurement,
   generating the calibration data set includes combining the respective calibration measurements of each primary sensor of the plurality of primary sensors, and
   combining the respective calibration measurements includes aligning respective coordinate systems of each primary sensor of the plurality of primary sensors; and
calibrating each primary sensor of the plurality of primary sensors based on known properties of the calibration artifact, a known mounting location of the calibration artifact with respect to the manufacturing machine, and the calibration data set.

Clause 39: The method of clause 1, wherein:
the workpiece is mounted on a workpiece movement mechanism of the manufacturing machine,
gathering the first data set includes measuring the first feature using a plurality of primary sensors,
each primary sensors of the plurality of primary sensors performs a respective measurement of the first feature from a respective angle, and
gathering the first data set includes combining the respective measurements from each primary sensor of the plurality of primary sensors to generate the first data set.

Clause 40: The method of clause 39 further comprising:
measuring a calibration artifact mounted on the workpiece movement mechanism of the manufacturing machine with each primary sensor of the plurality of primary sensors to generate a calibration data set, wherein:
   each primary sensor of the plurality of primary sensors generates a respective calibration measurement,
   generating the calibration data set includes combining the respective calibration measurements of each primary sensor of the plurality of primary sensors, and
   combining the respective calibration measurements includes aligning respective coordinate systems of each primary sensor of the plurality of primary sensors; and
calibrating each primary sensor of the plurality of primary sensors based on known properties of the calibration artifact, a known mounting location of the calibration artifact with respect to the manufacturing machine, and the calibration data set.

Clause 41: The method of clause 1 wherein the manufacturing machine is an additive manufacturing machine.

Clause 42: The method of clause 1 wherein the manufacturing machine is a hybrid manufacturing machine.

Clause 43: A manufacturing controller comprising:
a primary sensor;
memory hardware configured to store computer-executable instructions; and
processor hardware configured to execute the computer-executable instructions, wherein the computer-executable instructions embody the methods of any of clauses 1-42.

Clause 44: The manufacturing controller of clause 43 wherein the primary sensor is fixedly mounted to a frame of the manufacturing machine.

Clause 45: A manufacturing system comprising:
the manufacturing controller of clause 43; and
the manufacturing machine.

Clause 46: A manufacturing controller comprising:
a primary sensor;
cloud-based memory configured to store computer-executable instructions; and
processor hardware configured to execute the computer-executable instructions, wherein the computer-executable instructions embody the methods of any of clauses 1-42.

Clause 47: A method comprising:
receiving data associated with a workpiece mounted in a manufacturing machine;
following performance of a first machining operation on the workpiece by the manufacturing machine that generates a first feature on the workpiece, gathering a first data set;
gathering a second data set;
determining a difference data set based on differences between the first data set and the second data set;
modifying the data based on the difference data set; and
causing the manufacturing machine to use the modified data in performing an additional machining operation on the workpiece.

Clause 48: The method of clause 47 wherein modifying the data includes generating a modified data set based on the difference data set, and the manufacturing machine uses the modified data set to perform the additional machining operation.

Clause 49: The method of any of clauses 47-48 wherein the data includes at least one of: computer-aided manufacturing (CAM) code, computer-aided design (CAD) code, digital twin data, design intent data, or point cloud data.

Clause 50: The method of any of clauses 47-49 wherein gathering the first data set includes measuring the first feature using a primary sensor.

Clause 51: The method of clause 50 further comprising: aligning a coordinate system of the manufacturing machine with a coordinate system of the primary sensor.

Clause 52: The method of clause 50 wherein the primary sensor is a non-contact sensor.

Clause 53: The method of any of clauses 47-52 wherein gathering the first data set includes measuring the first feature using a primary sensor and a secondary sensor.

Clause 54: The method of any of clauses 47-53 wherein gathering the second data set includes retrieving the second data set from the data.

Clause 55: The method of any of clauses 47-54 wherein gathering the second data set includes measuring the first feature using a secondary sensor.

Clause 56: The method of clause 55 wherein:
the manufacturing machine includes a spindle that retains a removal tool used in the first machining operation, and
the secondary sensor is affixed to the spindle and remains affixed to the spindle while the first machining operation is performed.

Clause 57: The method of clause 55 wherein the secondary sensor is a contact sensor.

Clause 58: The method of any of clauses 47-57 wherein the manufacturing machine includes a workpiece movement mechanism configured to receive the workpiece.

Clause 59: The method of any of clauses 47-58 further comprising:
measuring a calibration artifact mounted in the manufacturing machine using a primary sensor to generate a calibration data set; and
calibrating the primary sensor based on known properties of the calibration artifact, a known mounting location of the calibration artifact with respect to the manufacturing machine, and the calibration data set.

Clause 60: A manufacturing controller comprising:
a primary sensor;
memory hardware configured to store computer-executable instructions; and
processor hardware configured to execute the computer-executable instructions, wherein the computer-executable instructions embody the methods of any of clauses 47-59.

Clause 61: A manufacturing system comprising:
the manufacturing controller of clause 60; and
the manufacturing machine.

1. A method of machining a workpiece, the method comprising:
receiving a calibration data set associated with a primary sensor, wherein:
the calibration data set is generated from measurements, by the primary sensor, of a calibration artifact mounted to a workpiece movement mechanism of a manufacturing machine at a plurality of orientations of the workpiece movement mechanism,
the primary sensor defines a sensor coordinate system that is independent of movement of the workpiece movement mechanism, and
the calibration data set defines a calibration transformation that relates (i) a coordinate system of the workpiece movement mechanism at each of the plurality of orientations to (ii) the sensor coordinate system;
receiving machining data associated with the workpiece, wherein:
the machining data defines nominal three-dimensional geometry of a plurality of intended states of the workpiece including a first intermediate state and a final state,
the machining data is defined in a nominal coordinate system, and
a first portion of the machining data defines a first material-modification operation to form a first feature on the workpiece corresponding to the first intermediate state of the workpiece;
following mounting of the workpiece to the workpiece movement mechanism and performance of the first material-modification operation on the workpiece using a machining tool, and while the workpiece remains mounted to the workpiece movement mechanism, measuring the first feature with the primary sensor to obtain primary-sensor measurement data;
generating a first data set based on (i) the primary-sensor measurement data, (ii) orientation data of the workpiece movement mechanism during measurement of the first feature, and (iii) the calibration data set, wherein the first data set includes calibrated three-dimensional geometry of the first feature that is corrected, based on the calibration data set, for deviations introduced by the workpiece movement mechanism during measurement of the first feature;
obtaining a second data set from the first portion of the machining data, wherein the second data set includes nominal three-dimensional geometry of the first feature in the nominal coordinate system;
determining, with tied coordinate systems, a difference data set including geometric differences between the calibrated three-dimensional geometry of the first feature and the nominal three-dimensional geometry of the first feature, wherein the tied coordinate systems include:
the sensor coordinate system,
the nominal coordinate system, and
a machine coordinate system associated with an actual tool-end path of the machining tool relative to the workpiece movement mechanism during formation of the first feature, wherein the actual tool-end path reflects a cumulative machining effect including:
manufacturing-machine-motion deviation,
machining-tool deviation, and
machining-tool-workpiece interaction during the first material-modification operation; and
modifying a following portion of the machining data by applying at least one transformation among the tied coordinate systems to compensate for the difference data set, wherein:
the following portion defines a subsequent material-modification operation after the first intermediate state, and
the subsequent material-modification operation is performed, using the following portion of the machining data as modified, before the workpiece is removed from the workpiece movement mechanism.

2. The method of claim 1 wherein the machining data includes at least one of computer-aided design (CAD) code, digital twin data, design intent data, point cloud data, or computer-aided manufacturing (CAM) code.

3. The method of claim 1 further comprising causing the manufacturing machine to perform the first material-modification operation on the workpiece using the machining tool.

4. The method of claim 3 further comprising causing the manufacturing machine, before the workpiece is removed from the workpiece movement mechanism, to perform the subsequent material-modification operation using the following portion of the machining data as modified.

5. The method of claim 1 wherein the first data set is expressed in the sensor coordinate system.

6. The method of claim 1 wherein the primary sensor is fixed with respect to the manufacturing machine.

7. The method of claim 1 further comprising generating the calibration data set by measuring, using the primary sensor, the calibration artifact mounted to the workpiece movement mechanism at the plurality of orientations of the workpiece movement mechanism.

8. The method of claim 7 further comprising determining, after the calibration data set is generated and before the subsequent material-modification operation is performed, whether to repeat calibration based on at least one of an elapsed calibration period, a number of workpieces processed by the manufacturing machine, a number of machining operations performed by the manufacturing machine, an environmental change in the manufacturing machine, or a tolerance associated with the workpiece.

9. The method of claim 1 wherein the first material-modification operation is a material removal operation.

10. The method of claim 1 further comprising:
generating secondary measurement data by measuring, with a secondary sensor, an aspect of the first feature that is not captured by the primary-sensor measurement data; and
generating the first data set based on both the primary-sensor measurement data and the secondary measurement data.

11. The method of claim 10 wherein:
a spindle of the manufacturing machine retains the machining tool; and
the secondary sensor is retained by or affixed to the spindle while performing measurements with the secondary sensor.

12. The method of claim 10 wherein the measuring with the secondary sensor is performed while at least one of the secondary sensor or the workpiece is moved by the manufacturing machine in a motion corresponding to motion during the first material-modification operation.

13. The method of claim 1 wherein:
the manufacturing machine includes at least one of a computer numerical control (CNC) machine, a robot, an additive manufacturing machine, a subtractive manufacturing machine, or a hybrid manufacturing machine; and
the primary sensor includes at least one of a camera, a laser scanner, a tactile sensor, an x-ray sensor, or a fringe projection system.

14. The method of claim 1 wherein the workpiece movement mechanism includes a rotary mechanism configured to rotate the workpiece around a vertical axis.

15. The method of claim 1 wherein:
the primary sensor includes a plurality of primary sensors,
each primary sensor of the plurality of primary sensors measures the first feature from a respective angle to generate a respective measurement, and
the primary-sensor measurement data includes the respective measurements from the plurality of primary sensors.

16. The method of claim 15 wherein:
the calibration data set is generated from respective calibration measurements of the calibration artifact by the plurality of primary sensors, and
generating the calibration data set includes aligning respective coordinate systems of the plurality of primary sensors.

17. The method of claim 1 wherein:
the following portion defines a plurality of subsequent material-modification operations, including the subsequent material-modification operation, after the first intermediate state;
the at least one transformation is applied to the plurality of subsequent material-modification operations; and
the plurality of subsequent material-modification operations is performed, using the following portion of the machining data as modified, before the workpiece is removed from the workpiece movement mechanism.

18. The method of claim 1 further comprising:
generating a log based on at least one of the difference data set or the at least one transformation,
wherein the log is usable for at least one of part certification, updating a digital twin, training an artificial intelligence model, updating an artificial intelligence model, or further manufacturing optimization.

19. The method of claim 1 wherein modifying the following portion of the machining data includes calculating correction information for one or more locations of the workpiece not included in the first feature by at least one of interpolation, extrapolation, or an artificial intelligence model based on the difference data set.

20. The method of claim 1 wherein:
the first feature includes a temporary reference feature formed on the workpiece for determining the difference data set, and
the subsequent material-modification operation at least partially removes the temporary reference feature from the workpiece.
